(19) United States
(12) Patent Application Publication
(10) Pub. No.: US 2013/0039051 A1
(43) Pub. Date: Feb. 14, 2013

(54) STRUCTURE OF LIGHT TUBE

(71) Applicant: Chih-Hsien WU, New Taipei City (TW)

(72) Inventor: Chih-Hsien WU, New Taipei City (TW)

(21) Appl. No.: 13/207,578

(22) Filed: Aug. 11, 2011

(51) Int. Cl. F21V 29/00

(52) U.S. Cl. 362/218

(57) ABSTRACT

A structure of light tube includes a cover, a heat dissipation element, at least one lighting unit, and two caps. The cover forms therein a receiving chamber. The cover has a wall which forms at least one heat dissipation opening in communication with the receiving chamber. The heat dissipation element is arranged inside the receiving chamber. The lighting unit includes a substrate and at least one light-emitting diode. The light-emitting diode is coupled to and electrically connected with the substrate. The substrate is coupled to the heat dissipation element. The two caps are respectively fit to opposite ends of the cover, and each of the caps forms therein a receiving chamber and at least one projection. The projection is formed on an inside surface of the cap and projects into the receiving chamber of the cap to be corresponding to and engageable with the heat dissipation opening.

### FIELD OF THE INVENTION

The present invention relates to a structure of light tube, and in particular to a structure of light tube that prevents invasion of foreign objects and provides sound coupling.

### BACKGROUND OF THE INVENTION

To improve brightness and range of lighting in an environment of poor lighting, a lighting device with internally arranged light tube is often used. The lighting device generally comprises at least one light tube, a base, and a cover. The cover is coupled to the base and the light tube is housed in the cover so that light emitting from the light tube can be converged and projected to realize lighting.

Recently, the technology of light-emitting diode (LED) get quickly mature, making it possible to embody a lighting module by mounting a plurality of LEDs on a circuit board that controls lighting of the LEDs. Compared to the early technologies, a lighting device with internally built in lighting module is more compact in size and is also advantageous for being of reduced power consumption and thus green. A light tube that comprises such a lighting module accommodated in the tube or attached to one side of the tube is available in the market. in this way, the number of LEDs used in a lighting device is increased and the brightness so induced is improved. However, a severe heat problem accompanies such designs. To overcome the heat problems, a heat dissipation element is additionally mounted to the circuit board in order to properly dissipate the heat generated by the lighting module while improving brightness and range of lighting.

Heat dissipation elements that are commonly used are made of aluminum extrusions. When these heat dissipation elements are mounted inside the structure of light tube, the structure of light tube must be perforated in order to help dissipating heat. However, such perforation may becomes an access for humidity, insects, and dusts to get into the light tube, which might cause undesired negative influence on the lighting brightness and also on the electrical connection between components (such as poor electrical engagement). On the other hand, when the heat dissipation element is attached to one side of the light tube, the heat dissipation element is at least partly exposed outside the light tube, leading to potential risk of inadvertent contact with the heat dissipation and occurrence of electrical shock to a user in making replacement of component and thus causing undesired damage.

Thus, the present invention aims to provide a structure of light tube that prevents invasion of foreign objects, provides sound and secure coupling, is easy to manufacture, is ready to assemble and disassemble, and provides protection against inadvertent electrical shock, so that the convenience of use is enhanced.

### SUMMARY OF THE INVENTION

An objective of the present invention is to provide a structure of light tube that prevents invasion of foreign objects, provides sound and secure coupling, is easy to manufacture, is ready to assemble and disassemble, and prevents inadvertent contact that leads to electrical shocking.

To realize the above objective, the present invention provides a structure of light tube that comprises a cover, which forms therein a receiving chamber, the cover having a wall in which at least one heat dissipation opening is formed, the heat dissipation opening being in communication with the receiving chamber; a heat dissipation element, which is arranged inside the receiving chamber; at least one lighting unit, which comprises a substrate and at least one light-emitting diode, the light-emitting diode being coupled to and electrically connected with the substrate, the substrate being coupled to the heat dissipation element; and two caps, which are respectively fit to opposite ends of the cover, each of the caps forming therein a receiving chamber and at least one projection, the projection being formed on an inside surface of the cap and projecting into the receiving chamber of the cap to be corresponding to and engageable with the heat dissipation opening. As such, advantages of preventing invasion of foreign objects, providing sound and secure coupling, being easy to manufacture, being ready to assemble and disassemble, and providing protection against inadvertent electrical shock are realized and the convenience of use is enhanced.

### BRIEF DESCRIPTION OF THE DRAWINGS

The present invention will be apparent to those skilled in the art by reading the following description of a preferred embodiment thereof with reference to the drawings, in which:

FIG. 1 is a perspective view showing a structure of light tube constructed in accordance with the present invention;

FIG. 2 is an exploded view of FIG. 1; and

FIG. 3 is a cross-sectional view taken along line A-A of FIG. 1.

### DETAILED DESCRIPTION OF THE PREFERRED EMBODIMENT

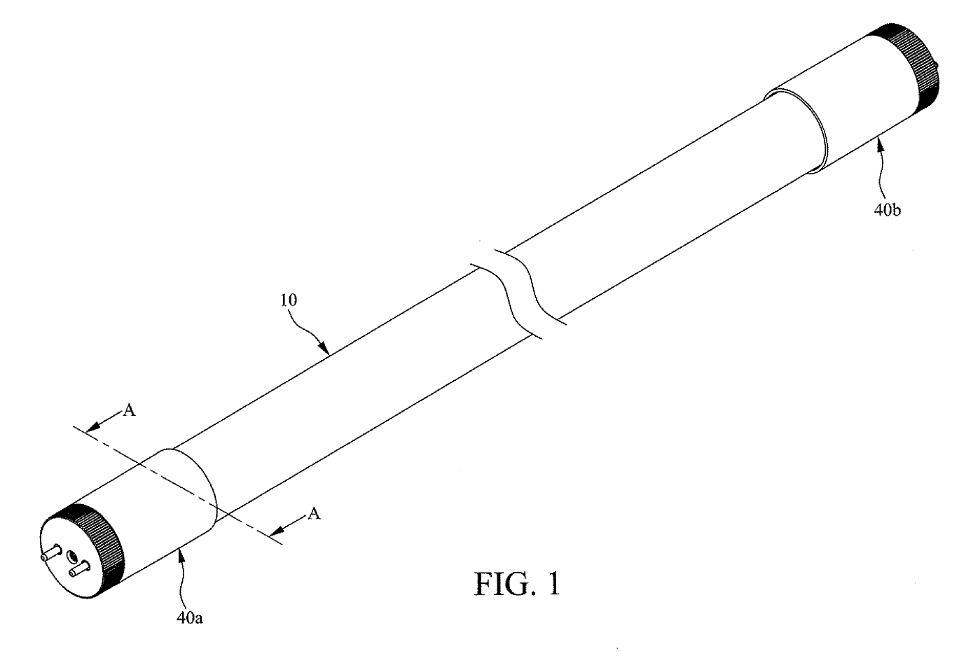

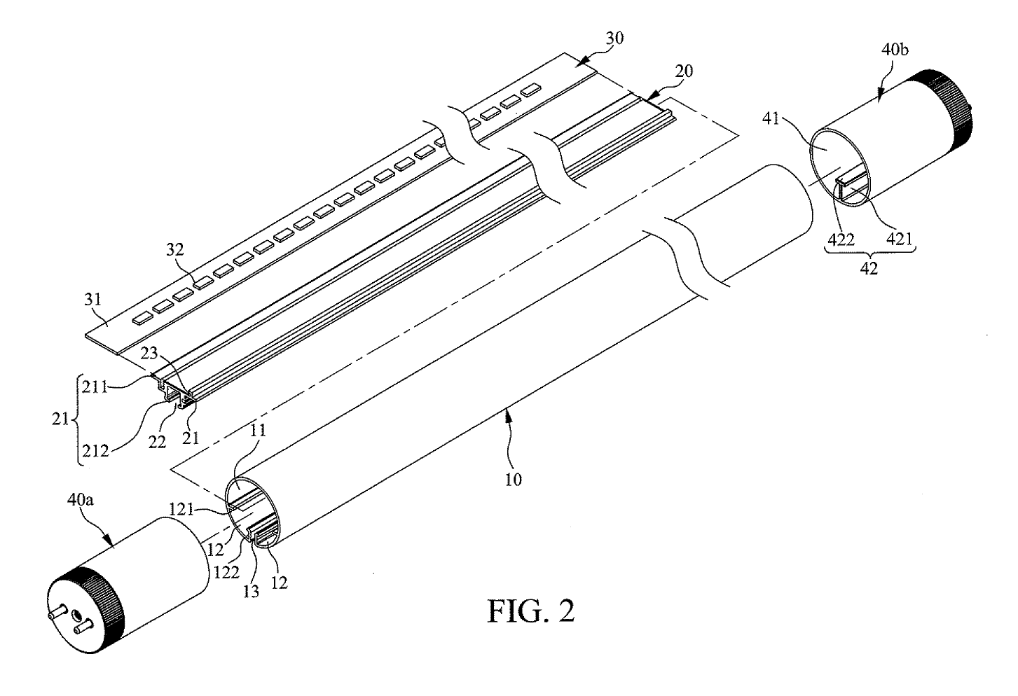

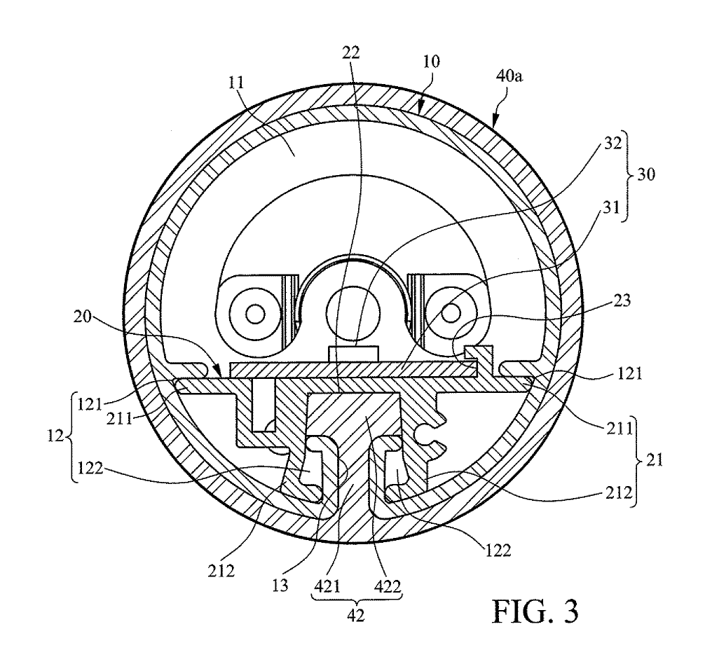

With reference to the drawings and in particular to FIGS. 1-3, a structure of light tube is shown, comprising a cover 10, a heat dissipation element 20, at least one lighting unit 30, and two caps 40a, 40b.

The cover 10 forms therein a receiving chamber 11. The cover 10 has a wall in which at least one heat dissipation opening 13 is formed. The heat dissipation opening 13 is in communication with the receiving chamber 11. The heat dissipation element 20 is arranged inside the receiving chamber 11. The lighting unit 30 comprises a substrate 31 and at least one light-emitting diode 32. The light-emitting diode 32 is coupled to and electrically connected with the substrate 31. The substrate 31 is coupled to the heat dissipation element 20. The two caps 40a, 40b are respectively fit to opposite ends of the cover 10. Each cap 40a, 40b forms therein a receiving compartment 41 and at least one projection 42. The projection 42 is formed on an inside surface of the cap and projects into the receiving chamber 41 of the cap to be corresponding to and engageable with the heat dissipation opening 13 of the cover 10.

In the embodiment, the projection 42 comprises a vertical plate 421 and a horizontal plate 422. The vertical plate 421 is erected on the inside surface of the cap 10, and the horizontal plate 422 is jointed to the vertical plate 421 to make the projection 42 a T-shape. However, the present invention does not limit the projection 42 to be such a shape and/or structure.

The cover 10 is of a hollow tubular configuration with the heat dissipation opening 13 extending in a direction coincident with an axis of the cover 10 from one end of the wall of the cover 10 to the wall of the opposite end of the cover 10. Each cap 40a, 40b has an end forming an electrical connection section. The electrical connection section is connectable with an external power supply and is electrically connected with conductors to the lighting unit 30. Each cap 40a, 40b has an opposite end that is open and forms a coupling section. The opposite ends of the cover 10 are respectively fit into the receiving compartments 41 of the two caps 40a, 40b and thus enclosed and protected by the two caps 40a, 40b against invasion of foreign objects, such as humidity, insets, and dust, into the cover 10. The cover 10 and the substrate 31 are each integrally formed so that the structure of light tube according to the present invention can be easily manufactured and is easy to assemble/disassemble and replace.

Further, the cover 10 forms at least one receiving channel 12 inside the receiving chamber 11. The receiving channel 12 is located adjacent to a wall of the cover at the heat dissipation opening 13. The heat dissipation element 20 comprises at least one guide section 21, which corresponds to and is engageable with the receiving channel 12, so that the heat dissipation element 20 can be securely retained inside the receiving chamber 11 without undesired sliding movement.

To have the receiving channel 12 and the guide section 21 securely coupled to each other without undesired sliding movement, each receiving channel 12 comprises a first guide slot 121 and a second guide slot 122. Each guide section 21 also comprises a side wing 211 and a side arm 212. The first guide slot 121 is formed in a side wall of the receiving channel 12 and is corresponding to and engageable with the side wing 211. The second guide slot 122 is formed in an opposite side wall of the receiving channel 12 and is corresponding to and engageable with the side arm 212. The side wing 211 extends from a side edge of the heat dissipation element 20, while the side arm 212 extends from a bottom of the heat dissipation element 20.

In a case where a guide section 21 is formed on each of opposite sides of the heat dissipation element 20, two side arms 212 are formed to respectively extend from opposite sides of the bottom end of the heat dissipation element 20, whereby the bottom end of the heat dissipation element 20 defines a retention slot 22 that corresponds to and is engageable with the projections 42 of the caps 40a, 40b. The portions of the wall of the cover that are located on opposite sides of the heat dissipation opening 13 each form a receiving channel 12 corresponding to and engageable with each of the guide sections 21, whereby when the projections 42 are fit into and expand the heat dissipation opening 13, the two side arms 212 are respectively set in tight engagement with the second guide slots 122 on the opposite sides of the heat dissipation opening 13 to prevent foreign objects, such as humidity, insects, and dust, from entering the cover 10. On the other hand, the horizontal plate 422 of the projection 42 is fit into the retention slot 22 to provide a sound and firm coupling, whereby the coupling between the cover 10 and the heat dissipation element 20 can be made secure and the heat dissipation element 20 is prevented from sliding off the cover 10 in proceeding with replacement, and also, a user is protected against electrical shock caused by accidentally contacting the heat dissipation element 20. Further, the heat dissipation opening 13 allows of air flowing therethrough for dissipation of heat.

Further, the heat dissipation element 20 forms in a top thereof a fitting groove 23, which receives an edge of the substrate 31 to fit therein. As such, warping of the substrate 31 caused by improper application of force in mounting the substrate 31 can be prevented. An example of the substrate 31 used in the present invention is a circuit board.

In summary, the structure of light tube according to the present invention comprises an assembled combination of a cover 10, a heat dissipation element 20, at least one lighting unit 30, and two caps 40a, 40b, in order to prevent invasion of foreign objects, provide sound and secure coupling, be easy to manufacture, be ready to assemble and disassemble, and prevent inadvertent contact that leads to electrical shocking, thereby enhancing the convenience of use.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A structure of light tube, comprising:
a cover, which forms therein a receiving chamber, the cover having a wall in which at least one heat dissipation opening is formed, the heat dissipation opening being in communication with the receiving chamber;
a heat dissipation element, which is arranged inside the receiving chamber;
at least one lighting unit, which comprises a substrate and at least one light-emitting diode, the light-emitting diode being coupled to and electrically connected with the substrate, the substrate being coupled to the heat dissipation element; and
two caps, which are respectively fit to opposite ends of the cover, each of the caps forming therein a receiving chamber and at least one projection, the projection being formed on an inside surface of the cap and projecting into the receiving chamber of the cap to be corresponding to and engageable with the heat dissipation opening of the cover.

2. The structure of light tube as claimed in claim 1, wherein the projection comprises a vertical plate and a horizontal plate, the vertical plate being erected on the inside surface of the cap, the horizontal plate being jointed to the vertical plate.

3. The structure of light tube as claimed in claim 2, wherein the projection is of a T-shape.

4. The structure of light tube as claimed in claim 1, wherein the cover is of a hollow tubular configuration, the heat dissipation opening extending in a direction coincident with an axis of the cover from one end of the wall of the cover to the wall of the opposite end of the cover.

5. The structure of light tube as claimed in claim 1, wherein the cover forms at least one receiving channel inside the receiving chamber, the receiving channel being located adjacent to a wall of the cover at the heat dissipation opening, the heat dissipation element comprising at least one guide section, which corresponds to and is engageable with the receiving channel.

6. The structure of light tube as claimed in claim 5, wherein the receiving channel comprises a first guide slot and a second guide slot, the guide section comprising a side wing and a side arm, the first guide slot being formed in a side wall of the receiving channel and corresponding to and engageable with the side wing, the second guide slot being formed in an opposite side wall of the receiving channel and corresponding to and engageable with the side arm, the side wing extending from a side edge of the heat dissipation element, the side arm extending from a bottom of the heat dissipation element.

7. The structure of light tube as claimed in claim 1, wherein the heat dissipation element forms a retention slot in a bottom thereof to correspond to and be engageable with the projections of the caps.

8. The structure of light tube as claimed in claim 1, wherein the heat dissipation element has a top forming a fitting groove to receive an edge of the substrate to fit therein.
